(19) United States
(12) Patent Application Publication
(10) Pub. No.: US 2003/0103601 A1
(43) Pub. Date: Jun. 5, 2003

(54) Call handler interface with personal response features and associated method

(75) Inventors: Susan Wagner, Riverwoods, IL (US); Kerry Lee Starr, Palm Bay, FL (US); Mohsen Alhadad, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Golden Voice Technology and Training L.L.C., Highland Park, IL

(21) Appl. No.: 10/005,707

(22) Filed: Dec. 3, 2001

(51) Int. Cl. H04M 1/64; H04M 3/00

(52) U.S. Cl. 379/67.1; 379/265.01

(57) ABSTRACT

A call handler interface includes a housing, a telephone line port carried by the housing to be connected to a telephone line, and a telephone headset port carried by the housing to be connected to a telephone headset. An amplifier is connectable between the telephone line port and the telephone headset port for amplifying and coupling signals therebetween. A personalized message storage and retrieval circuitry is carried by the housing and is connected to the amplifier for permitting a call handler to store at least one message in a voice of the call handler and selectively retrieve the stored personalized message for playing to a caller on the telephone line.

### FIELD OF THE INVENTION

The present invention relates to the field of computers and telephony, and more particularly, to a call handler or other call operator interface.

### BACKGROUND OF THE INVENTION

A significant advance in telephony systems is disclosed, for example, in U.S. Pat. Nos. 4,623,761; 4,697,282; 4,734,930 and RE 35,758 assigned to the present assignee, and which are incorporated herein by reference in their entirety. These patents disclose a personalized message storage and retrieval system capable of presenting to the caller played-back, previously recorded response messages perceived to be in the actual voice of the call handler on duty at the time. The call handler is also able to follow-up the played back, previously recorded response message with a conversation with the caller, without the caller detecting a change in the characteristics of the call handler's perceived voice.

The personalized message storage and retrieval system employs a voice synthesizer coupled between a response message memory and an audio interface to the call handler's headset. After the storage of a series of response messages prepared by the call handler, the system is ready for use in answering incoming calls. In this playback mode, as incoming calls are monitored, the appropriate call handler's voice enunciated response message is accessed from memory and, via the voice synthesizer and the audio interface, that message is played back to the caller.

Throughout the call, the call handler, who is on line the entire time has been relieved of the need to actually recite the response phrase, and can now proceed to converse with the caller. Of course, the call handler can interact spontaneously with the caller, as well. The audio interface contains a level control circuit which ensures that there is effectively no difference in the recorded voice played back to the caller and the “live” voice spoken by the call handler. As a result, the personalized message storage and retrieval system is listener transparent.

The personalized message storage and retrieval system, when combined with the call handler's headset in a typical installation, includes a number of individual components. For example, if the microphone in the call handler's headset is a high impedance microphone, then a separate amplifier is required. This amplifier is typically carried by the call handler's headset, i.e., in the cord connected thereto. Accordingly, the call handler's position may suffer from a certain degree of clutter, especially in view of the cables between components.

### SUMMARY OF THE INVENTION

In view of the foregoing background, it is therefore an object of the present invention to provide a call handler interface and an associated method which reduces the number of discrete components or units, and which may also provide a lower cost.

This and other objects, features and advantages in accordance with the present invention are provided by a call handler interface comprising a housing, a telephone line port carried by the housing to be connected to a telephone line, and a telephone headset port carried by the housing to be connected to a telephone headset.

The call handler interface preferably includes an amplifier carried by the housing and connectable between the telephone line headset port and the telephone headset port for amplifying and coupling signals therebetween. Personalized message storage and retrieval circuitry is also preferably carried by the housing and connected to the amplifier for permitting a call handler to store at least one message in a voice of the call handler and selectively retrieve the stored personalized message for playing to a caller on the telephone line.

The call handler interface advantageously allows the number of discrete system components to be reduced. In addition, since the circuitry can share portions, such as power supplies, amplifiers, etc., the call handler interface can be less expensive than the total cost of multiple corresponding discrete components. Moreover, the lower cost call handler interface can be used in many applications, such as conventional receptionist applications where phrases, such as a company's or firm's name, for example, are necessarily repeated many times throughout the day.

The call handler interface may further include at least one call handler interface switch carried by the housing, and control logic circuitry carried by the housing for controlling the personalized message storage and retrieval circuitry based upon the at least one call handler interface switch. The at least one call handler interface switch may further include a first set of function switches, and a second set of personalized message selection switches. Respective function indicators may be carried by the housing and associated with the first set of function switches.

The call handler interface may also include a level control circuit carried by the housing that is connected to the amplifier for controlling at least a playback level for a personalized message. Accordingly, the caller is not aware that a prerecorded message is being played.

An external control port may be carried by the housing and is connected to the control logic circuitry for permitting external control of the personalized message storage and retrieval circuitry. A handset port may also be carried by the housing and connectable to the amplifier for permitting connection of a telephone handset thereto. Consequently, at least one selector switch may be carried by the housing for selectively connecting the telephone headset port or the telephone handset port to the amplifier.

In one embodiment, the personalized message storage and retrieval circuitry preferably comprises a connector and a memory device removably mated with the connector. The memory device is for storing the at least one message in a voice of the call handler. The memory device may be a card or memory stick, for example, that is carried by the particular call handler for use at any given call handler position.

The telephone line input port and/or the telephone line headset port may be wireless. Alternatively, the telephone line input port and/or the telephone line headset port may comprise a connector. In some embodiments the headset may be separate and in others embodiments the headset is carried by the housing.

Another aspect of the present invention relates to an automated call distribution (ACD) system comprising an ACD device and a plurality of call handler work stations connected thereto. Each work station preferably comprises a call handler display for displaying information to a call handler, a call handler input device for accepting call handler inputs, and a call handler interface as described above.

Yet another aspect of the present invention relates to a telephone system comprising at least one key telephone set and at least one call handler interface connected thereto, with the call handler interface as described above. The at least one key telephone set may also be connected to a private branch exchange.

A further aspect of the present invention relates to a method for making a call handler interface. The method may comprise providing a housing with a telephone line port and telephone headset port carried by the housing, and providing an amplifier in the housing that is connectable between the telephone line headset port and the telephone headset port for amplifying and coupling signals therebetween. The method may also include providing personalized message storage and retrieval circuitry carried by the housing that is connected to the amplifier for permitting a call handler to store at least one message in a voice of the call handler and selectively retrieve the stored at least one personalized message for playing to a caller on the telephone line.

### BRIEF DESCRIPTION OF THE DRAWINGS

FIG. 1 is a schematic block diagram of an automated call distribution (ACD) system including a call handler interface in accordance with the present invention.

FIGS. 2 and 3 are schematic block diagrams of different embodiments of a telephone system including the call handler interface in accordance with the present invention.

FIG. 4 is a more detailed block diagram of the call handler interface in accordance with the present invention.

FIG. 5 is a top plan view of the call handler interface for illustrating various function and control switches in accordance with the present invention.

FIG. 6 is a more detailed block diagram of an alternate embodiment of the call handler interface in accordance with the present invention.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation is used in alternate embodiments to indicate similar elements.

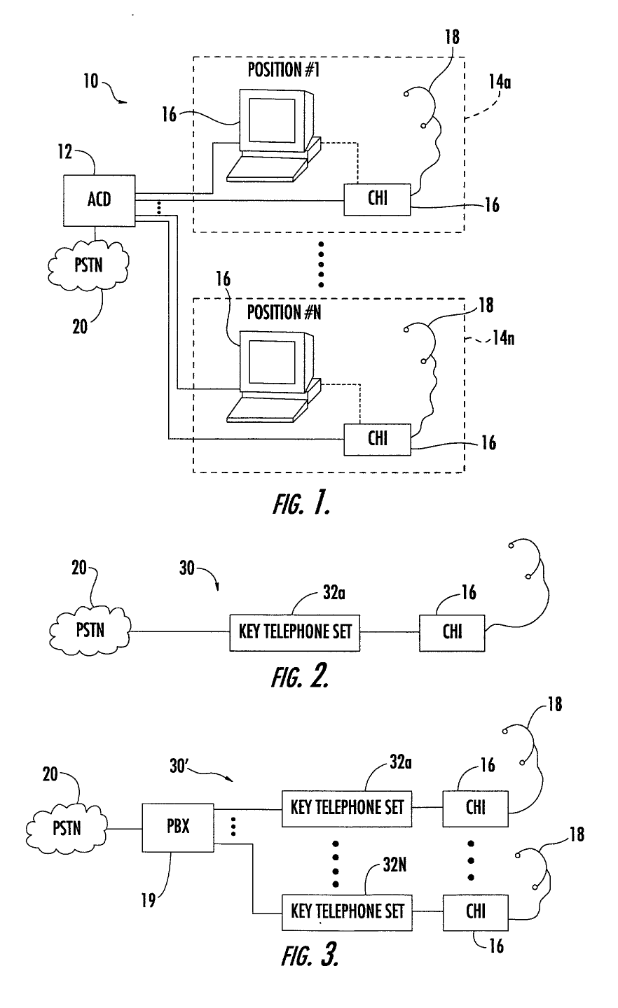

Referring initially to FIG. 1, an automated call distribution (ACD) system 10 comprising an ACD device 12 and a plurality of call handler work stations 14a-14n connected thereto is now described. The ACD system 10 includes a call handler interface 16 in accordance with the present invention. Each call handler work station 14a-14n includes a computer 16, and a telephone headset 18 for the call handler's use. The ACD system 10 is also connected to the public switched telephone network (PSTN) 20 as will be appreciated by those skilled in the art.

As will be described in greater detail below, the call handler interface 16 advantageously contains both personalized message storage and retrieval circuitry and an amplifier for the telephone headset 18. As discussed above, such circuitry in the past was typically provided in completely separate components. For example, if the microphone in the call handler's headset 18 is a high impedance microphone, then a separate amplifier would be required. This amplifier is typically carried by the call handler's headset 18, i.e., in the cord connected thereto. The call handler interface 16 in accordance with the present invention thus advantageously allows the number of discrete system components to be reduced. Accordingly, a call handler can experience less clutter in their working environment.

As will also be described in greater detail below, the personalized message storage and retrieval circuitry permits a call handler to store at least one message in a voice of the call handler and selectively retrieve the stored personalized message for playing to a caller on the telephone line. The call handler interface 16 may advantageously be used by a call handler where phrases, such as a company's or firm's name, for example, are necessarily repeated many times throughout the day.

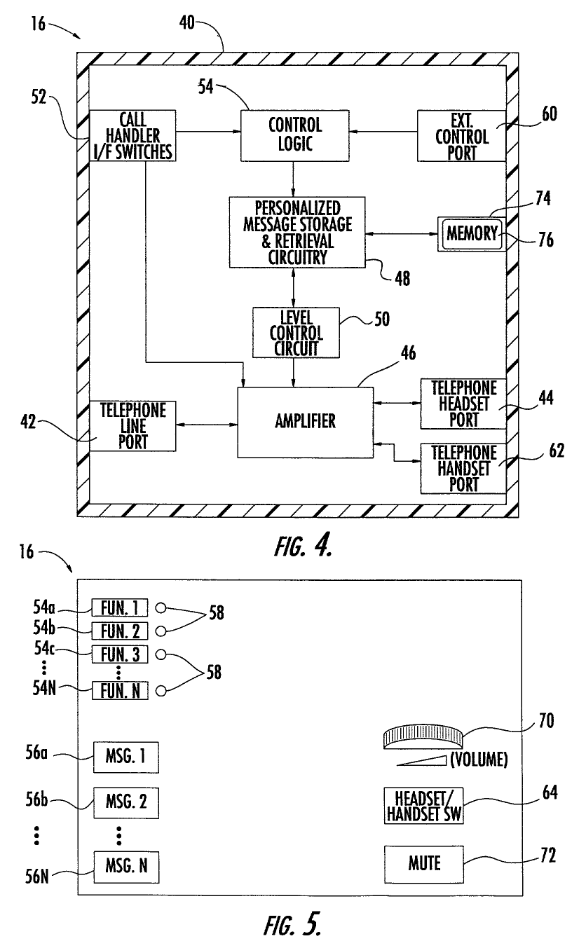

In addition to the call handler interface 16 being applicable to an ACD system 10, it is also applicable to a standard telephone system, different embodiments of which will now be described with reference to FIGS. 2 and 3. In one embodiment, the telephone system 30 comprises a single key telephone set 32a, a call handler interface 16 and a telephone headset 18 connected thereto for the call handler's use as illustrated in FIG. 2. The key telephone set 32a is further connected to a PSTN 20 as will be appreciated by those skilled in the art.

In another embodiment, the telephone system 30′ comprises a plurality of single key telephone sets 32a-32n, a plurality of respective call handler interfaces 16 and a plurality of respective telephone headsets 18 connected thereto as illustrated in FIG. 3. The plurality of key telephone sets 32a-32n are further connected to a private branch exchange (PBX) 19 which is also connected to the PSTN 20 as will be appreciated by those skilled in the art.

Turning-now additionally to FIGS. 4-6, the call handler interface 16 will now be described in greater detail. The call handler interface 16 includes a portable housing 40, a telephone line port 42 carried by the housing to be connected to a telephone line, and a telephone headset port 44 carried by the housing to be connected to a telephone headset 18.

The call handler interface 16 further includes an amplifier 46 connectable between the telephone line port 42 and the telephone headset port 44 for amplifying and coupling signals therebetween. Personalized message storage and retrieval circuitry 48 is carried by the housing 40 and is connected to the amplifier 46 for permitting a call handler to store at least one message in a voice of the call handler and selectively retrieve the stored personalized message for playing to a caller on the telephone line.

The call handler interface 16 advantageously includes both the personalized message storage and retrieval circuitry 48 and the amplifier 46 for the telephone headset 18. Such circuitry in the past was typically provided in completely separate components, each with its own respective housing, power supply, telephone line and/or telephone headset ports, etc. The call handler interface 16 thus allows the number of discrete system components to be reduced, which allows a call handler to experience less clutter in their working environment, which may include the ACD system 10 or one of the telephone embodiments 30, 30′ illustrated in FIGS. 1-3.

In addition, since the circuitry can share portions, such as power supplies, amplifiers, etc., the call handler interface 16 can be less expensive than the total cost of multiple corresponding discrete components. Moreover, the lower cost call handler interface 16 can be used in many applications, such as conventional receptionist applications where phrases are necessarily repeated many times throughout the day.

The personalized message storage and retrieval circuitry 48 may be of the types as disclosed in U.S. Pat. Nos. 4,623,761; 4,697,282; 4,734,930 and RE 35,758, the entire disclosures of which are incorporated herein by reference and are assigned to the assignee of the present invention. Those of skill in the art will readily appreciate the various constructions of such personalized message storage and retrieval circuitry 48 without further explanation.

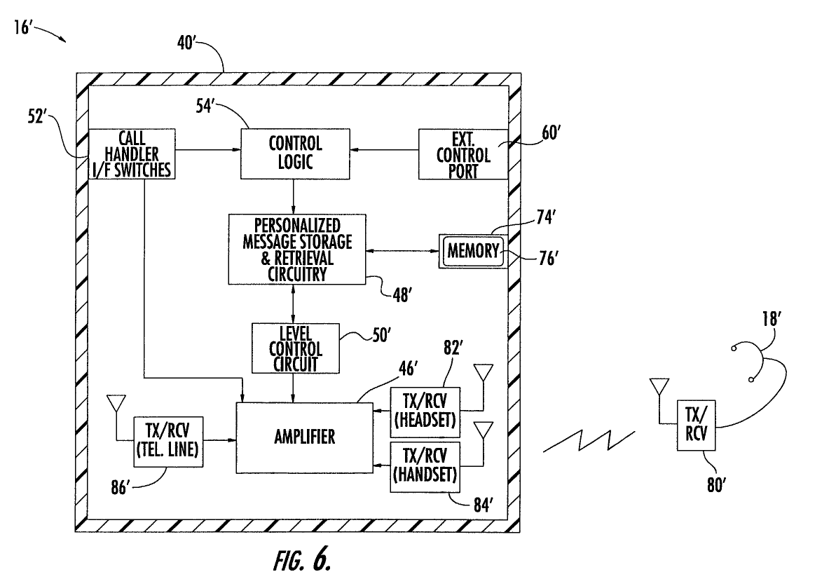

The call handler interface 16 includes a level control circuit 50 carried by the housing 40 and connected to the amplifier 46 for controlling at least a playback level for a personalized message. The level control circuit 50 matches the playback level to the live call handler so that caller is not aware that a prerecorded message is being played. A volume control 70 is connected to the level control circuit 50, for example, for permitting the call handler to select a desired playback level, as best illustrated in FIG. 5. In addition, a mute switch 72 may be connected to the amplifier 46 for muting the call handler.

The call handler interface 16 further includes at least one call handler interface switch 52 carried by the housing 40, and control logic circuitry 54 carried by the housing for controlling the personalized message storage and retrieval circuitry 48 based upon the at least one call handler interface switch 52.

More particularly, the at least one call handler interface switch 52 comprises a first set of function switches 54a-54n, and a second set of personalized message selection switches 56a-56n. Function indicators 58 may also be carried by the housing 40 and associated with the first set of function switches 54a-54n.

The first set of function switches 54a-54n may include a record function switch for recording a personalized message, for example. A corresponding indicator 58, such as an LED, for example, may be used to indicate when a particular function has been selected or activated. Other function switches manual or automatic selection to permit either manual operator selection of the message to be played or automatic selection of the message to be played. Of course, in some embodiments only manual or automatic circuitry may be included. The details of the circuitry associated with these particular function switches will be readily appreciated by those skilled in the art without further explanation.

Personalized messages that have been recorded are selected by the call handler by selecting one of the personalized message selection switches 56a-56n corresponding to a desired message. The personalized message storage and retrieval circuitry 48 may also include a connector 74 and a memory device 76 removably mated with the connector, wherein the memory device stores different messages in a voice of the call handler. This allows different call handlers to use the same call handler interface 16 without having to reprogram the personalized messages to be played, or allows the same call handler to use a different call handler interface 16 without also having to the reprogram the personalized messages to be played.

An external control port 60 is carried by the housing 40 and is connected to the control logic circuitry 54 for permitting external control of the personalized message storage and retrieval circuitry 48. External control would allow the call handler to select a personalized message without having to use the second set of personalized message selection switches 56a-56n.

In addition to the housing 40 carrying a telephone headset port 44, the housing further includes a telephone handset port 62 that may be connected to the amplifier 46 for permitting connection of a telephone handset thereto. In other words, the call handler may use either a telephone headset 18 or a telephone handset by selecting at least one selector switch 64 carried by the housing 40 for selectively connecting the telephone headset port 44 or the telephone handset port 62 to the amplifier 46.

An alternate embodiment of the call handler interface 16′ in accordance with the present invention will now be described with reference to FIG. 6. In this embodiment, a wireless communication link may be established to the telephone headset 18′. More particularly, a wireless transceiver 80′ (combination transmitter and receiver) may be provided at the headset 18′, and a corresponding wireless transceiver 82′ is provided within the common housing 40′. In addition, the telephone handset port 62 may include a wireless transceiver 84′ for establishing a wireless communication link to a telephone handset.

The wireless transceivers 80′, 82′ and 84′ may be radio frequency or infrared devices, for example, as will be appreciated by those skilled in the art. In addition, although a unidirectional wireless link is illustrated, in other embodiments a bi-directional link may be provided.

A wireless communication link may also be established via the telephone line port 42 to a key telephone set 32a or an ACD 12. More particularly, a wireless transceiver 86′ may be provided within the common housing 40′ for communicating with a corresponding transceiver (not shown) in one of these devices, as readily appreciated by those skilled in the art. Other circuit portions not specifically mentioned, but indicated with prime notation, are similar to those described above, and require no further discussion.

Another aspect of the present invention relates to a method for making a call handler interface 16. The method includes providing a housing 40 with a telephone line port 42 and telephone headset port 44 carried by the housing, and providing an amplifier 46 in the housing that is connectable between the telephone line headset port and the telephone headset port for amplifying and coupling signals therebetween. The method also includes providing personalized message storage and retrieval circuitry 48 carried by the housing 40 that is connected to the amplifier 46 for permitting a call handler to store at least one message in a voice of the call handler and selectively retrieve the stored at least one personalized message for playing to a caller on the telephone line.

Many modifications and other embodiments of the invention will come to the mind of one skilled in the art having the benefit of the teachings presented in the foregoing descriptions and the associated drawings. For example, the call handler interface 16 may include a headset carried by the housing 40. Therefore, it is to be understood that the invention is not to be limited to the specific embodiments disclosed, and that modifications and embodiments are intended to be included within the scope of the appended claims.

That which is claimed is:

1. A call handler interface comprising:
a housing;
a telephone line port carried by said housing to be connected to a telephone line;
a telephone headset port carried by said housing to be connected to a telephone headset;
an amplifier carried by said housing connectable between said telephone line port and said telephone headset port for amplifying and coupling signals therebetween; and
personalized message storage and retrieval circuitry carried by said housing and connected to said amplifier for permitting a call handler to store at least one message in a voice of the call handler and selectively retrieve the stored at least one personalized message for playing to a caller on the telephone line.

2. A call handler interface according to claim 1 further comprising a level control circuit carried by said housing and connected to said amplifier for controlling at least a playback level for a personalized message.

3. A call handler interface according to claim 1 further comprising:
at least one call handler interface switch carried by said housing; and
control logic circuitry carried by said housing for controlling said personalized message storage and retrieval circuitry based upon said at least one call handler interface switch.

4. A call handler interface according to claim 3 wherein said at least one call handler interface switch comprises:
a first set of function switches; and
a second set of personalized message selection switches.

5. A call handler interface according to claim 4 further comprising respective function indicators carried by said housing and associated with said first set of function switches.

6. A call handler interface according to claim 3 further comprising an external control port carried by said housing and connected to said control logic circuitry for permitting external control of said personalized message storage and retrieval circuitry.

7. A call handler interface according to claim 1 further comprising a handset port carried by said housing and connectable to said amplifier for permitting connection of a telephone handset thereto.

8. A call handler interface according to claim 7 further comprising at least one selector switch carried by said housing for selectively connecting said headset port or said handset port to said amplifier.

9. A call handler interface according to claim 1 wherein said personalized message storage and retrieval circuitry comprises a connector and a memory device removably mated with said connector; said memory device for storing the at least one message in a voice of the call handler.

10. A call handler interface according to claim 1 further comprising a mute switch carried by said housing and connected to said amplifier for muting the call handler.

11. A call handler interface according to claim 1 wherein said telephone line input port comprises a wireless telephone line port.

12. A call handler interface according to claim 1 wherein said telephone line headset port comprises a wireless telephone line headset port.

13. A call handler interface according to claim 1 wherein said telephone line input port comprises a telephone line connector.

14. A call handler interface according to claim 1 wherein said telephone line headset port comprises a wireless telephone line headset connector.

15. A call handler interface according to claim 1 further comprising a headset carried by said housing.

16. An automated call distribution (ACD) system comprising:
an ACD device and a plurality of call handler work stations connected thereto, each work station comprising a call handler display for displaying information to a call handler, a call handler input device for accepting call handler inputs, and a call handler interface comprising
a housing,
a telephone line port carried by said housing to be connected to said ACD device,
a telephone headset port carried by said housing to be connected to a telephone headset,
an amplifier carried by said housing and connectable between said telephone line port and said telephone headset port for amplifying and coupling signals therebetween, and
personalized message storage and retrieval circuitry carried by said housing and connected to said amplifier for permitting a call handler to store at least one message in a voice of the call handler and selectively retrieve the stored at least one personalized message for playing to a caller on the telephone line.

17. An ACD system according to claim 16 further comprising a level control circuit carried by said housing and connected to said amplifier for controlling at least a playback level for a personalized message.

18. An ACD system according to claim 16 further comprising:
at least one call handler interface switch carried by said housing; and
control logic circuitry carried by said housing for controlling said personalized message storage and retrieval circuitry based upon said at least one call handler interface switch.

19. An ACD system according to claim 18 wherein said at least one call handler interface switch comprises:
a first set of function switches; and
a second set of personalized message selection switches.

20. An ACD system according to claim 19 further comprising respective function indicators carried by said housing and associated with said first set of function switches.

21. An ACD system according to claim 18 further comprising an external control port carried by said housing and connected to said control logic circuitry for permitting external control of said personalized message storage and retrieval circuitry.

22. An ACD system according to claim 16 further comprising a handset port carried by said housing and connectable to said amplifier for permitting connection of a telephone handset thereto.

23. An ACD system according to claim 22 further comprising at least one selector switch carried by said housing for selectively connecting said headset port or said handset port to said amplifier.

24. An ACD system according to claim 16 wherein said personalized message storage and retrieval circuitry comprises a connector and a memory device removably mated with said connector; said memory device for storing the at least one message in a voice of the call handler.

25. An ACD system according to claim 16 further comprising a mute switch carried by said housing and connected to said amplifier for muting the call handler.

26. A telephone system comprising:
at least one key telephone set and at least one call handler interface connected thereto, said call handler interface comprising
a housing,
a telephone line port carried by said housing to be connected to said at least one key telephone set,
a telephone headset port carried by said housing to be connected to a telephone headset,
an amplifier carried by said housing and connectable between said telephone line port and said telephone headset port for amplifying and coupling signals therebetween, and
personalized message storage and retrieval circuitry carried by said housing and connected to said telephone headset amplifier for permitting a call handler to store at least one message in a voice of the call handler and selectively retrieve the stored at least one personalized message for playing to a caller on the telephone line.

27. A telephone system according to claim 26 further comprising a private branch exchange connected upstream of said at least one key telephone set.

28. A telephone system according to claim 26 further comprising a level control circuit carried by said housing and connected to said amplifier for controlling at least a playback level for a personalized message.

29. A telephone system according to claim 26 further comprising:
at least one call handler interface switch carried by said housing; and
control logic circuitry carried by said housing for controlling said personalized message storage and retrieval circuitry based upon said at least one call handler interface switch.

30. A telephone system according to claim 29 wherein said at least one call handler interface switch comprises:
a first set of function switches; and
a second set of personalized message selection switches.

31. A telephone system according to claim 30 further comprising respective function indicators carried by said housing and associated with said first set of function switches.

32. A telephone system according to claim 29 further comprising an external control port carried by said housing and connected to said control logic circuitry for permitting external control of said personalized message storage and retrieval circuitry.

33. A telephone system according to claim 26 further comprising a handset port carried by said housing and connectable to said amplifier for permitting connection of a telephone handset thereto.

34. A telephone system according to claim 33 further comprising at least one selector switch carried by said housing for selectively connecting said headset port or said handset port to said amplifier.

35. A telephone system according to claim 26 wherein said personalized message storage and retrieval circuitry comprises a connector and a memory device removably mated with said connector; said memory device for storing the at least one message in a voice of the call handler.

36. A telephone system according to claim 26 further comprising a mute switch carried by said housing and connected to said amplifier for muting the call handler.

37. A method for making a call handler interface comprising:
providing a housing with a telephone line port and telephone headset port carried by the housing;
providing an amplifier in the housing and connectable between the telephone line port and the telephone headset port for amplifying and coupling signals therebetween; and
providing personalized message storage and retrieval circuitry carried by the housing and connected to the amplifier for permitting a call handler to store at least one message in a voice of the call handler and selectively retrieve the stored at least one personalized message for playing to a caller on the telephone line.

38. A method according to claim 37 further comprising providing a level control circuit carried by the housing and connected to the amplifier for controlling at least a playback level for a personalized message.

39. A method according to claim 37 further comprising providing:
at least one call handler interface switch carried by the housing; and
control logic circuitry carried by the housing for controlling the personalized message storage and retrieval circuitry based upon the at least one call handler interface switch.

40. A method according to claim 39 wherein the at least one call handler interface switch comprises:
a first set of function switches; and
a second set of personalized message selection switches.

41. A method according to claim 39 further comprising an external control port carried by the housing and connected to the control logic circuitry for permitting external control of the personalized message storage and retrieval circuitry.

42. A method according to claim 37 further comprising providing a handset port carried by the housing that is connectable to the amplifier for permitting connection of a telephone handset thereto.
